(19) United States
(12) Patent Application Publication
(10) Pub. No.: US 2013/0087991 A1
(43) Pub. Date: Apr. 11, 2013

(54) Goose-neck Trailer Hitch Guide

(71) Applicant: Frederick T. Ingersoll, Verona, NY (US)

(72) Inventor: Frederick T. Ingersoll, Verona, NY (US)

(21) Appl. No.: 13/253,167

(22) Filed: Oct. 5, 2011

(51) Int. Cl. B60D 1/40

(52) U.S. Cl. 280/477

(57) ABSTRACT

A goose-neck trailer hitch guide uses a reference strap held by support posts attached by suction cups to opposite side walls of a truck. The reference strap is oriented in a plane between vertical and horizontal to face a driver in the tow vehicle who can then move a center indicator on the strap into alignment with a hitch pipe of the trailer until the strap touches the hitch pipe, which assuredly brings the hitch into registry with a hitch ball in the bed of the tow vehicle.

### TECHNICAL FIELD

Hitch guides for goose-neck trailers

### BACKGROUND

Bringing goose-neck trailers and their tow vehicles into registry for hitching them together is problematic. The driver of the tow vehicle, which is ordinarily a pick-up truck, usually cannot see the hitch ball, which is mounted in the bed of the truck. This suggests that a guide using something movable with the tow vehicle and something fixed on the trailer can help bring these two into registry.

The Maxwell U.S. Pat. No. 6,793,235, which is the closest prior art known to applicant, suggests such a guide for use in hitching up a goose-neck trailer with its tow vehicle. Embodiments of the invention of this application improve on the Maxwell suggestions in several important ways. The components used in applicant's embodiment are much less expensive than Maxwell's, and mounting applicant's guide components in place is both quicker and easier than mounting Maxwell's devices. The functional results obtained with applicant's embodiments meet everything the Maxwell devices can accomplish, and do so with less expensive and more compact equipment that is easier to use and more accurate in its results.

### SUMMARY

Applicant's supports for a reference strap spanning the distance between the sides of a truck have the advantage of being lightweight, low cost, and easy to install. The supports also position a center region of a reference strap in a plane obliquely facing the driver so that a center of the reference strap is readily visible without requiring auxiliary equipment. The strap supports are preferably simple plastic posts held in place with a pair of suction cups that are readily mounted on the outer sides of the truck body. Proper use of applicant's embodiments can help in preventing damage to a tow vehicle tailgate and a forward lower region of the gooseneck trailer. Finally, applicant's components assemble into a compact package that can fit in the glove box of a tow vehicle.

### DRAWINGS

FIG. 1 is a partially schematic, partially elevational view of gooseneck trailer and tow vehicle using applicant's trailer hitch guide.

FIG. 2 is a plan view looking downward from above a bed 14 of a tow vehicle 15 to show the reference strap and its supports. These also appear in the rearward view of FIG. 3.

FIG. 4 shows elevational views of a pair of reference strap supports as preferred for applicant's hitch guide.

FIG. 5 is a view through the rear window of the cab of a tow vehicle showing the reference strap aligned with the center of a gooseneck trailer hitch pipe.

FIGS. 6-8 show preferred alternatives for orienting reference strap 30 to obliquely face a driver while also allowing frictional support of a tensioned reference strap in parallel slots of different orientations.

FIG. 9 is a partially schematic and partially cut-away view of a stud that holds a suction cup on support posts.

FIGS. 10 and 11 are partially cross-sectional views of suction cups mounted in alternative ways to support posts.

FIGS. 12 and 13 show alternative elevational views of T-shaped support posts with horizontally arranged suction cups for mounting.

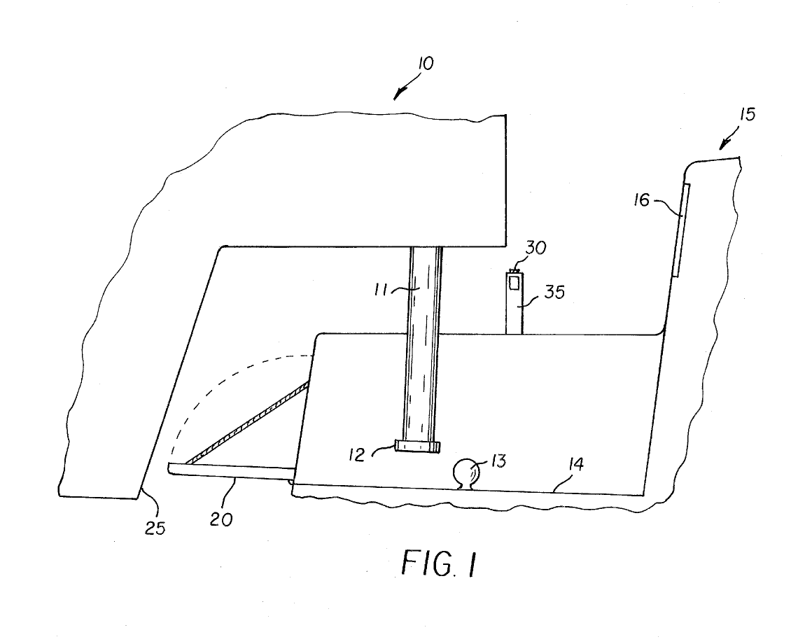

### DETAILED DESCRIPTION

The hitching guide of this application applies to gooseneck trailers 10 and tow vehicles 15, which are usually pick-up trucks. A hitch pipe 11 extends downward from a front region of a gooseneck trailer 10 to a hitch 12 that can mount on a hitch ball 13 mounted in the bed 14 of truck 15.

The vision of a driver of tow vehicle 15 looking through rear window 16 normally does not extend down to hitch ball 13. This makes a guide of some sort desirable so that the driver can back tow vehicle 15 under a forward end of trailer 10 to bring hitch 12 in registry with hitch ball 13. Doing this requires lowering of tailgate 20 so that tow vehicle 15 can back its bed 14 in under hitch pipe 11 and hitch 12, which are elevated somewhat above bed 14.

As hitch ball 13 approaches registry with hitch 12, it is wise for the driver or an assistant to close tailgate 20 by moving it up along the dotted line arc 21. This avoids banging tailgate 20 into the lower front region 25 of trailer 10.

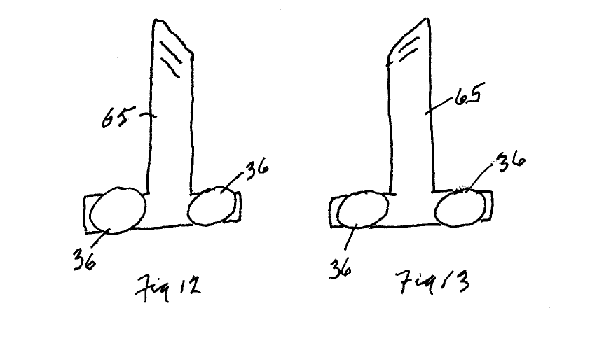

A reference strap 30 and supports 35 for reference strap 30 cooperate to enable a driver to back tow vehicle 15 into a position where hitch 12 reliably registers with hitch ball 13 to accomplish hitching trailer 10 to tow vehicle 15. Supports 35 each include a pair of suction cups 36, preferably arranged vertically or longitudinally of posts 35, so that the paired suction cups can hold each post 35 in a vertical orientation placing reference strap 30 well above the top rails 18 of truck sides 17. Suction cups 36 are lightweight, convenient, and reliable in holding posts 35 upright. They also fit any make or style of tow vehicle and are less expensive than magnets or other attaching devices. An alternative arrangement of suction cups 36, as shown in FIGS. 12 and 13, is mounted on T-shaped support posts 65. This requires a little more material for T-shaped support posts 65, but also allows suction cups 36 to mount upright strap supports securely on upper side regions of a truck.

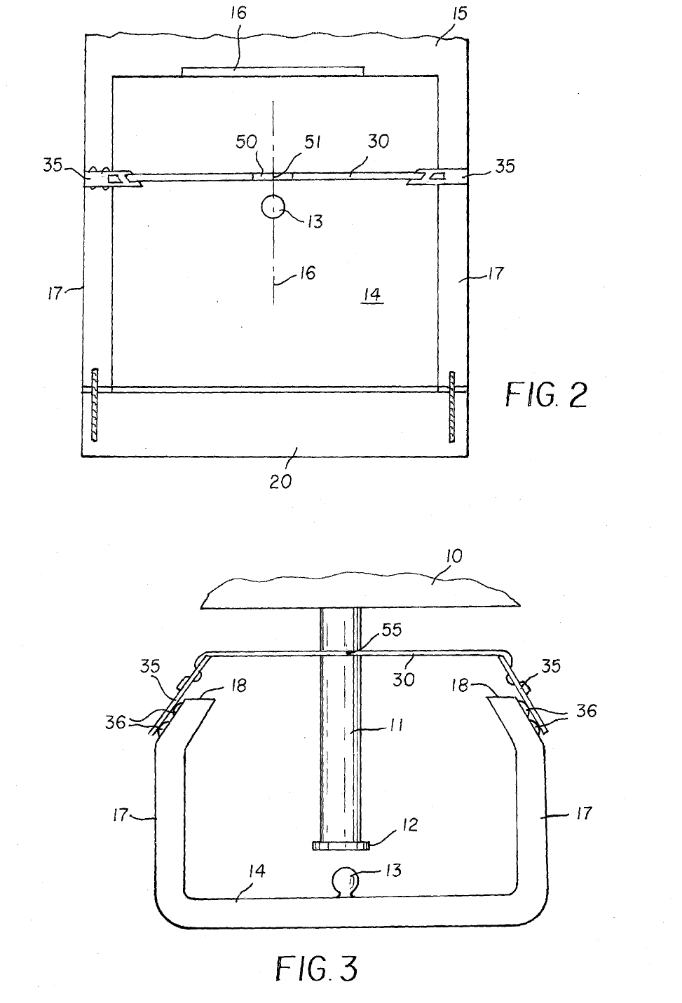

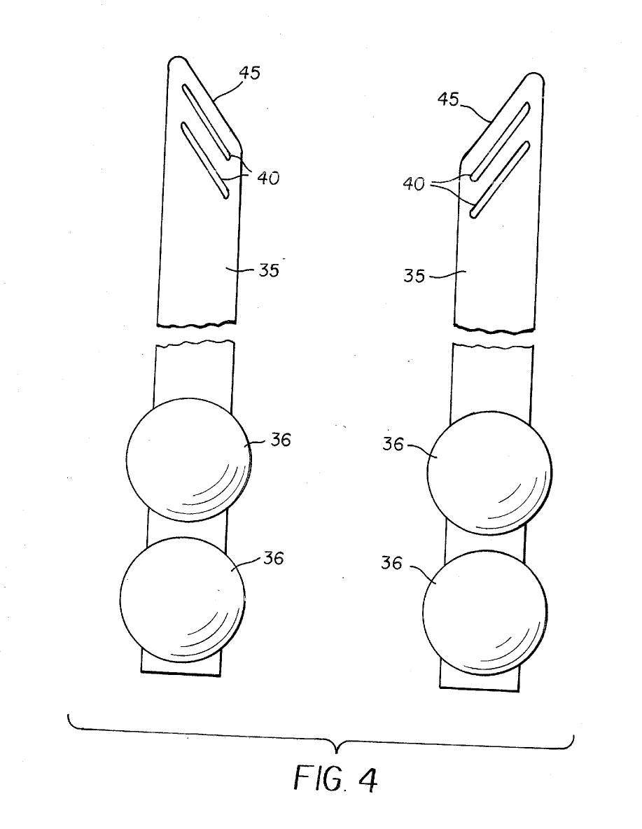

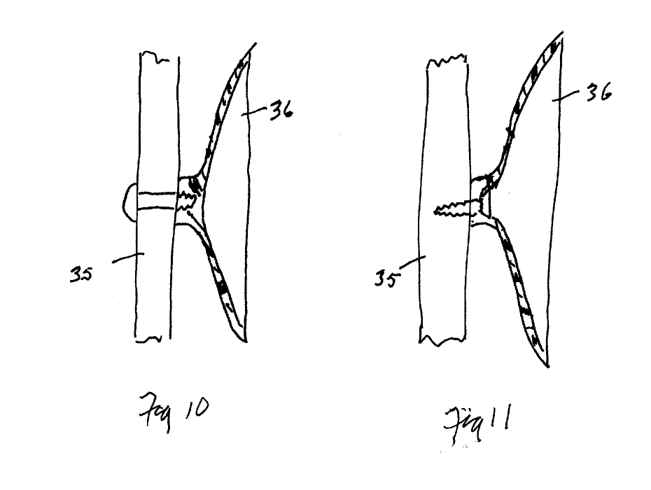

In FIG. 2, a longitudinal axis 16 of tow vehicle 15 is shown centered in truck bed 14. Hitch ball 13 is mounted on axis 16, and reference strap 30 is mounted just forward of hitch ball 13. Support posts 35 or 65 are mounted on opposite truck sides 17 by the suction cups 36. As shown in FIGS. 9-13, these are easily mounted on preferably plastic posts 35 or 65 by means of screws, as shown in FIGS. 10 and 11, or by a hole 37 properly positioned for each suction cup. Studs 38 are shaped to extend through holes 37 to support a head and neck 39 to which each suction cup is snap fitted. These arrangements hold each suction cup 36 securely in place on posts 35 or 65 so that the suction cups can be pressed into engagement with truck sidewalls 17 and can be unsnapped from such an engagement without coming loose.

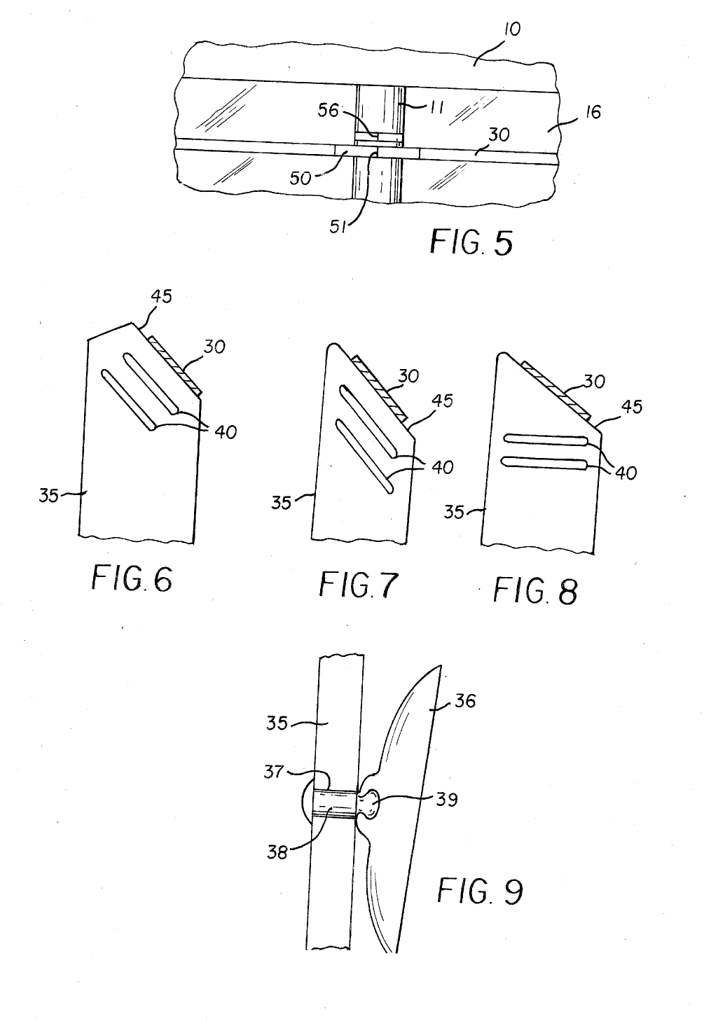

The FIG. 5 view through rear window 16 of the tow vehicle shows approaching alignment of trailer 10, hitch pipe 11, and reference strap 30, which can be a fabric strip about an inch wide. The sloped or beveled top 45 of posts 35 supports strap 30 at an oblique angle between vertical and horizontal to face a driver looking through rear window 16 of tow vehicle 15. The slope of upper post surfaces 45 is thus downward and toward a driver, who then sees a substantial width of strap 30, rather than an edge on view.

Installing applicant's hitch guide is preferably done when tow vehicle 15 and trailer 10 are connected. Suction cups for posts 35 or 65 are then attached to upper side walls 17 of truck bed 14 just forward of hitch ball 13. The posts then hold strap 30 tensioned in a horizontal direction spanning the truck sides 17 and positioned at least several inches above top rails 18 of truck sides 17.

Strap 30 then needs a center marker or indicator that can be aligned with the center of hitch pipe 11. For this purpose, a hook and loop fastener is one preferred possibility for a central foot or so of strap 30 where a center indicator can be attached. One part of the hook and loop fastener preferably bears a highly reflective tape attached to the counterpart of the hook and loop fastener to form a marker line. This can be a black mark or a color dividing line between different color portions of the tape. Either way, the tape marks a center point aligned with a forward facing center of the hitch pipe. The hook and loop application of a reflective center marker for reference strap 30 provides good visibility for a nighttime hitching operation and also allows accurate positioning of the center marker without much adjusting of the frictional connections between strap 30 and posts 35 or 65.

Simpler possibilities also exist. For example, a marker can apply a center mark to strap 30, without using a separate center marking tape. Alternatively, a center marking tape can be permanently stitched to strap 30 and can be positioned to register with hitch pipe 11 by adjusting the end regions of strap 30 on their support posts 35 or 65. This allows the important central region of strap 30 to be made highly reflective to aid in hitch alignment.

FIG. 3 shows a simple mark 55 made on strap 30 to serve as a center indicator. As viewed in FIG. 3, mark 55 is slightly to the right of the center of hitch pipe 11, and hitch ball 13 is also slightly to the right of hitch 12. This tells a driver to move the tow vehicle to bring reference mark 55 to the center of hitch pipe 11, which will then register hitch 12 with hitch ball 13.

Although center indicator 56 for hitch pipe 11 is not really required, especially in daylight, applying a highly reflective center marker 56 on pipe 11, as shown in FIG. 5, is helpful for nighttime hitching.

Once the hitch guide is assembled and centered on the tow vehicle, it becomes a simple and nearly foolproof matter to back the truck up to the trailer to accomplish a hitch. First, a tailgate of the truck is lowered so that the truck bed 14 can be backed under hitch pipe 11. It helps to have the tow vehicle and trailer lined up for this so that their longitudinal axes coincide. A hitch connection between a trailer and a tow vehicle angled relative to each other is possible though, and can be greatly assisted by use of applicant's hitch guide.

The tow vehicle can then be backed under hitch 12 and hitch pipe 11 to bring these to within a few inches of hitch ball 13. It is then wise to close the tailgate just to be sure there is not an accidental overshoot in bringing hitch 12 into registry with ball 13. The driver then continues backing gently until a center marker of reference strap 30 touches the front center of hitch pipe 11, which assures that hitch 12 is registered with ball 13. The rest of the hitching operation can proceed in the normal way, the hitch guide having assured that perfect registry occurs quickly and easily between tow vehicle 15 and trailer 10.

What is claimed is:

1. A goose-neck trailer hitch guide comprising:
a reference strap held by support posts attached to opposite side walls of a truck bed to support the reference strap above a level of side rails of the truck in a position observable through a rear window of the truck cab;
a pair of suction cups attaching each of the support posts to the truck side walls;
end regions of the reference strap being threaded through a pair of slots on each of the support posts so that the strap is frictionally tensioned between the support posts;
when supported by the posts, the reference strap has a truck center indicator visible to a driver in the truck cab; and
the reference strap being mounted slightly forward of a hitch ball in the truck bed so that the truck can back under a forward end of the trailer to bring the center indicator on the strap into contact with a center of a goose-neck hitch pipe to register a goose-neck hitch with the ball in the truck bed.

2. The guide of claim 1 including a center marker on the hitch pipe visible with the center indicator of the reference strap.

3. The guide of claim 1 wherein the center indicator for the reference strap is reflective and is secured to the reference strap.

4. The guide of claim 1 wherein the end regions of the reference strap are adjustable to register the center indicator of the strap with a center axis of the truck bed.

5. The guide of claim 1 wherein the support posts have angled upper ends that hold the reference strap in an oblique plane sloping downward and forward to face a driver of the truck.

6. The guide of claim 5 wherein the slots in the support posts are parallel with the angled upper ends of the posts.

7. A method of setting up and adjusting the goose neck trailer hitch guide of claim 1, the method comprising:
fastening the suction cups and the support posts on opposite sides of the truck bed so that the reference strap is slightly forward of the hitch ball in the bed of the truck;
bringing a center of the strap into registry with a center axis of the truck bed;
backing the truck under the front of the trailer to bring the hitch pipe within the bed of the truck;
closing a tailgate of the truck; and
further backing the truck to bring the reference strap into contact with the hitch pipe.

8. The method of claim 7 including the step of setting up the posts and the reference strap when the trailer is hitched to the truck and positioning the reference strap to touch the hitch pipe of the trailer.

9. A goose-neck trailer hitch guide comprising:
a pair of support posts arranged on opposite sides of a truck bed;
a pair of suction cups attaching each of the posts to an outside surface of the sides of the truck;
the posts extending above the level of the sides of the truck;
a strap extending between the posts and above the top of the sides of the truck;
end regions of the strap being threaded through slots in the posts to hold the strap in a tensioned position and allow lateral centering of the strap above the truck body;
the strap and posts being mounted slightly forward of a goose-neck hitch ball mounted in the bed of the truck;
the strap having a center point observable through the rear window of the cab of the truck; and
the strap and the posts being arranged so that when a center of a hitch pipe contacts the center point of the strap, a hitch on the hitch pipe is registered with the ball in the truck bed.

10. The guide of claim 9 including a center point indicator secured to the hitch pipe of the goose-neck trailer at the level of the strap.

11. The guide of claim 9 wherein the strap posts have top surfaces that are oblique to horizontal to dispose the strap in a plane visible to a driver in the truck.

12. The guide of claim 9 wherein the center point on the strap is marked by reflective material secured to the strap.

13. The guide of claim 9 wherein the center indicator is formed of reflective material for enhanced visibility.

14. A method of setting up and adjusting the hitch guide of claim 9, the method comprising:
attaching the suction cups and the posts to the sides of the truck;
bringing a center indicator of the strap into registry with a center axis of the truck bed slightly forward of the hitch ball in the truck bed; and
backing the truck under the trailer hitch pipe to bring the center of the strap into contact with a center of the hitch pipe.

15. The method of claim 14 including the step of setting up the posts and the reference strap when the trailer is hitched to the truck and positioning the reference strap to touch the hitch pipe of the trailer.

16. A goose-neck trailer hitch guide comprising:
a pair of support posts arranged on opposite sides of a truck bed;
a pair of suction cups attaching each of the posts to an outside surface of the sides of the truck;
the posts extending above the level of the sides of the truck;
a strap tensioned between top surfaces of the posts that are oblique to horizontal to dispose a mid-region of the strap in a plane sloping downward and forward so that a surface of the mid-region of the strap faces a rear window of the truck;
end regions of the strap being threaded through slots in the posts to hold the strap in a tensioned position and allow lateral centering of the strap above the truck body;
the strap having a center point observable through the rear window of the cab of the truck; and
the strap and the posts being arranged so that when a center of a hitch pipe contacts the center point of the strap, a hitch on the hitch pipe is registered with the ball in the truck bed.

17. The guide of claim 16 including a center marker on the hitch pipe visible with the center indicator of the reference strap.
